(19) United States
(12) Patent Application Publication
(10) Pub. No.: US 2016/0226165 A1
(43) Pub. Date: Aug. 4, 2016

(54) POWER CONNECTOR AND METHOD OF MAKING THE SAME

(71) Applicant: ALLTOP ELECTRONICS (SUZHOU) LTD., Taicang City (CN)

(72) Inventors: Wang-I YU, JHONGHE City (TW); I-Hung CHENG, JHONGHE City (TW)

(73) Assignee: ALLTOP ELECTRONICS (SUZHOU) LTD., Taicang City (CN)

(21) Appl. No.: 14/690,596

(22) Filed: Apr. 20, 2015

(30) Foreign Application Priority Data
Jan. 30, 2015 (CN) 201510051734.7

(51) Int. Cl. H01R 12/70; H01R 9/18; H01R 4/02; H01R 43/20; H01R 43/02

(52) U.S. Cl. CPC H01R 12/7076; H01R 43/20; H01R 43/02; H01R 4/02; H01R 9/18

(57) ABSTRACT

A power connector includes an insulative housing, a plurality of power contacts received in the insulative housing, a contact bus bar electrically connecting with the plurality of power contacts and a fastening element fastening the contact bus bar and an outer terminal arranged behind the insulative housing together. The insulative housing has a mating face at a front side thereof. The power contacts are provided with soldering pads, and the contact bus bar has a front mating pad engaging with the soldering pads. At least one in the front mating pad and the soldering pad is formed with a soldering hole. The front mating pad and the soldering pads are connected electrically via soldering tin set in the soldering hole.

### BACKGROUND

1. Technical Field

The present disclosure relates to an electrical connector, and more particularly to a power connector which can be produced and assembled easily and a method of making the same.

2. Description of Related Art

A conventional power connector usually includes a plurality of power contacts and a housing receiving the power contacts. Each power contact has a mating portion electrically connecting with a complementary connector and a soldering portion connecting with a printed circuit board or a terminal device. Generally, the mating portions and the soldering portions are provided correspondingly. In other words, each mating portion connects with a respective soldering portion. However, when the conventional power connector is used in an environment needing high electric current, the power contacts of such conventional power connector are easier to be invalid, which in turn make troubles for users.

TW patent application no. 201405977 discloses a power connector, which connects a plurality of power contacts and a contact bus bar together by a number of screws and nuts. Therefore, the current in the contact bus bar is equal to the total current through all the power contacts. However, the plurality of screws and nuts not only increase cost, but also are assembled complicated.

It is desirable to provide an improved power connector and a method of making the same for solving above problems.

### SUMMARY

In one aspect, the present invention includes a power connector. The power connector comprises an insulative housing, a plurality of power contacts received in the insulative housing, a contact bus bar electrically connecting with the plurality of power contacts and a fastening element fastening the contact bus bar and an outer terminal arranged behind the insualtive housing together. The insulative housing has a mating face at a front side thereof. The power contacts are provided with soldering pads, and the contact bus bar has a front mating pad engaging with the soldering pads. At least one in the front mating pad and the soldering pad is formed with a soldering hole. The front mating pad and the soldering pads are connected electrically via soldering tin set in the soldering hole.

In another aspect, the present invention further includes a method of making the power connector. The method includes providing a plurality of power contacts and an insulative housing, and fixing the power contacts to the insulative housing, the power contacts being provided with soldering pad; providing a contact bus bar and a fastening element and fastening the contact bus bar and an outer terminal together via the fastening element, the contact bus bar having a front mating pad to engaging with the power contacts, and at least one in the front mating pad and the soldering pad being formed with soldering hole; fixing the contact bus bar, the fastening element and the outer terminal to a rear side of the insulative housing and enabling the front mating pad of the contact bus bar abut against the soldering pad; and welding the soldering pads of the power contacts and the front mating pad at the position of the soldering hole via soldering tin.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view illustrating a first embodiment of a power connector in the present disclosure;

FIG. 2 is a view similar to FIG. 1, while viewed from another aspect;

FIG. 3 is a partially exploded view of the power connector shown in FIG. 1;

FIG. 4 is a view similar to FIG. 3, while viewed from another aspect;

FIG. 5 is an exploded view of the power contact, contact bus bar and fastening element of the power connector shown in FIG. 3;

FIG. 6 is a view similar to FIG. 5, while viewed from another aspect;

FIG. 7 is a perspective view illustrating a second embodiment of a power connector in the present disclosure;

FIG. 8 is a perspective view of the power contact, contact bus bar and fastening element of the power connector shown in FIG. 7;

FIG. 9 is a view similar to FIG. 8, while viewed from another aspect;

FIG. 10 is a partially exploded, perspective view of the power connector shown in FIG. 8;

FIG. 11 is a perspective view illustrating a third embodiment of a power connector in the present disclosure;

FIG. 12 is a perspective view of the power contact, contact bus bar and fastening element of the power connector shown in FIG. 11;

FIG. 13 is a partially exploded, perspective view of the power connector shown in FIG. 12;

FIG. 14 is a perspective view illustrating a fourth embodiment of a power connector in the present disclosure;

FIG. 15 is a perspective view of the power contact, contact bus bar and fastening element of the power connector shown in FIG. 14;

FIG. 16 is a partially exploded, perspective view of the power connector shown in FIG. 14.

### DETAILED DESCRIPTION OF THE ILLUSTRATED EMBODIMENT

Reference will now be made to the drawing figures to describe the embodiments of the present disclosure in detail. In the following description, the same drawing reference numerals are used for the same elements in different drawings.

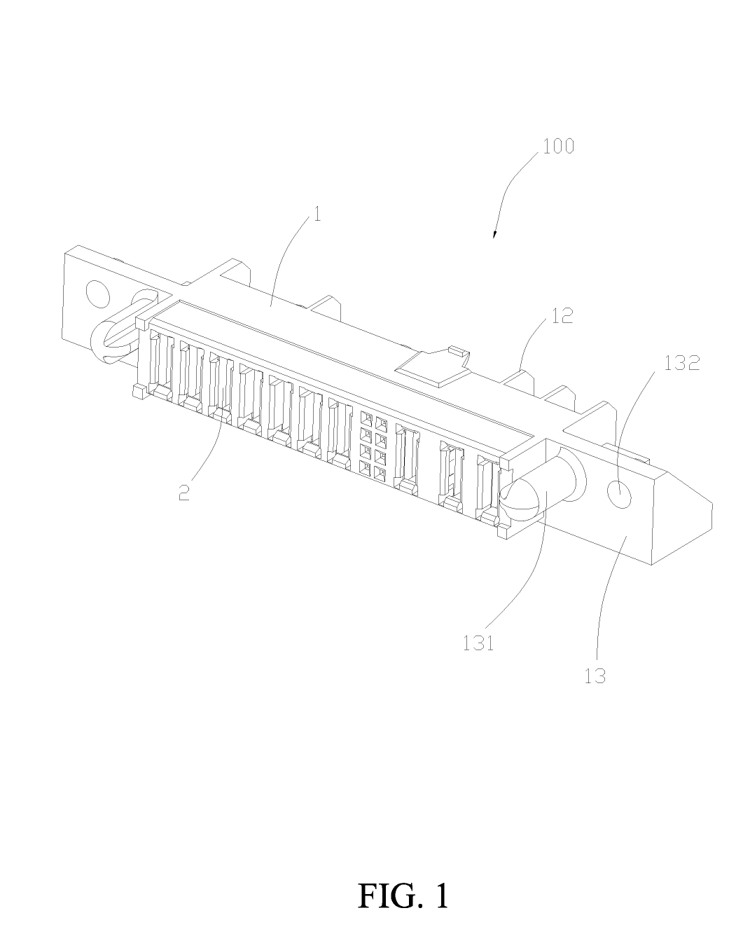

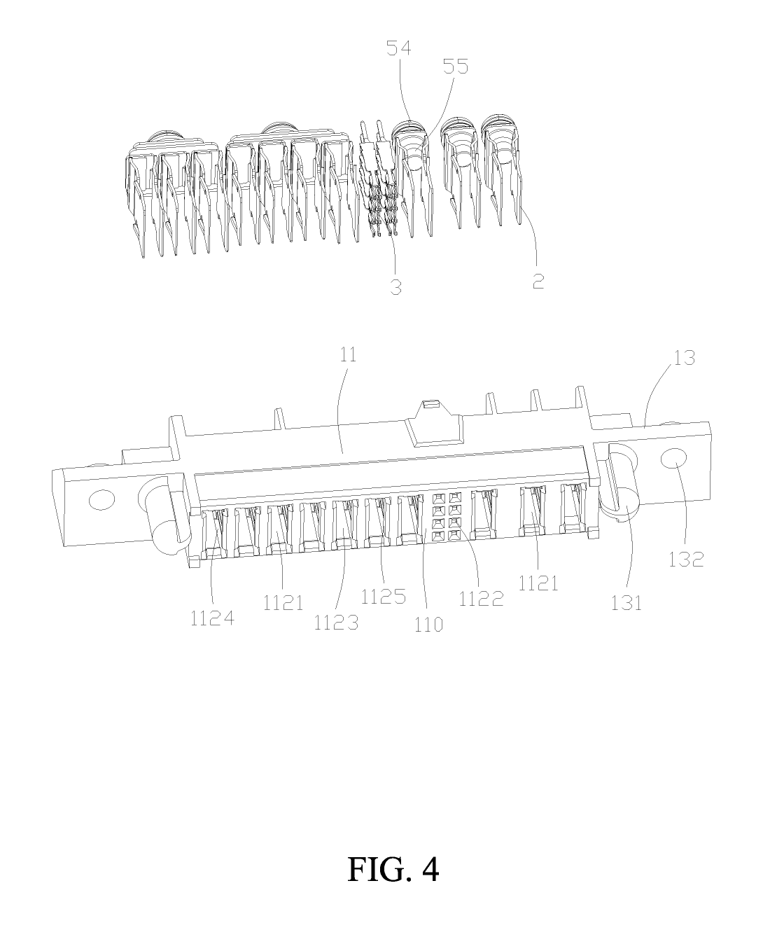

Referring to FIGS. 1 to 6, a first preferred illustrated embodiment of the present disclosure discloses a power connector 100. The power connector 100 comprises an insulative housing 1, a plurality of power contacts 2 and signal contacts 3 accommodated in the insulative housing 1, two contact bus bars 4 and two fastening members 5 mechanically and electrically fastening the contact bus bars 4 and two second outer terminals (not shown) together respectively.

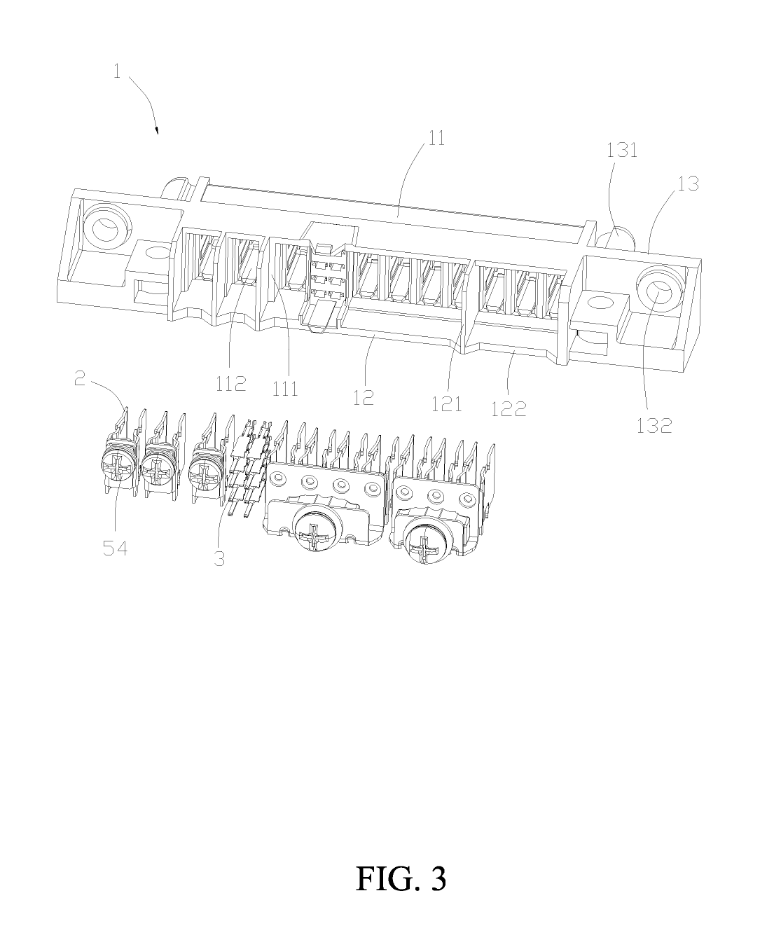

Please refer together to FIGS. 3-5, the insulative housing 1 comprises a main portion 11, an extension portion 12 backwardly extending from the main portion 11 and two side portions 13 located at two sides of the main portion 11. The side portion 13 is provided with a guide pole 131 which is close to the main portion 11 and a fixing hole 132 far from the main portion 11. The guide pole 131 is used to guide a mating connector inserting into the power connector 100, and the fixing hole 132 is used to fix the power connector 100 to an electronic device (not shown).

The main portion 11 has a mating face 110 at a front side thereof, a mounting face 111 at a rear side thereof and a plurality of receiving slots 112 extending through the mating face 110 and mounting face 111 along a front to back direction. In the present embodiment, the receiving slots 112 comprise a plurality of power contact slots 1121 and a plurality of signal contact slots 1122. The power contact slots 1121 are arranged along a transverse direction of the insulative housing 1. The signal contact slots 1122 are located between the power contact slots 1121.

Each power contact slot 1121 has a middle slot 1123 for receiving a mating contact and two position slots 1124 at two sides of the middle slot 1123. The position slots 1124 is wider than the middle slot 1123 along a top to bottom direction, and the position slots 1124 are formed with stop blocks 1125 at a front side thereof. The stop blocks 1125 prevent the power contacts 2 from moving forwardly. The extension portion 12 comprises a bottom wall 122 backwardly extending from a bottom side of the main portion 11 and a plurality of clapboards 121 backwardly extending from the mounting face 111. The clapboards 121 are perpendicular to the bottom wall 122, and the bottom wall 122 connects the bottom ends of the clapboards 121.

Please refer together to FIGS. 3-6, each power contact slot 1121 is arranged with a pair of power contacts 2. There are ten power contact slots 1121 corresponding to ten pairs of the power contacts 2 in the present invention. Each pair of the power contacts 2 comprises a first contact 21 and a second contact 22. Both the first contact 21 and the second contact 22 comprise a contacting pad 23 confronting to each other, a connecting pad 25 and a soldering pad 24 extending from a rear edge of the contacting pad 23. The connecting pads 25 and the soldering pads 24 of each pair of power contacts 2 extend toward each other respectively. The contacting pads 23 of the first and second contacts 21, 22 are received in the position slots 1124, and each contacting pad 23 is designed with a pair of resisting tabs 231 at upper and lower edges thereof. The position slots 1124 are formed with a limited block (not shown) at a rear side of the resisting tabs 231. The resisting tabs 231 resist the limited blocks to prevent the power contacts 2 from moving backwardly. The contacting pads 23 abut against a rear side of the stop blocks 1125 to limit the power contacts 2 from moving forwardly.

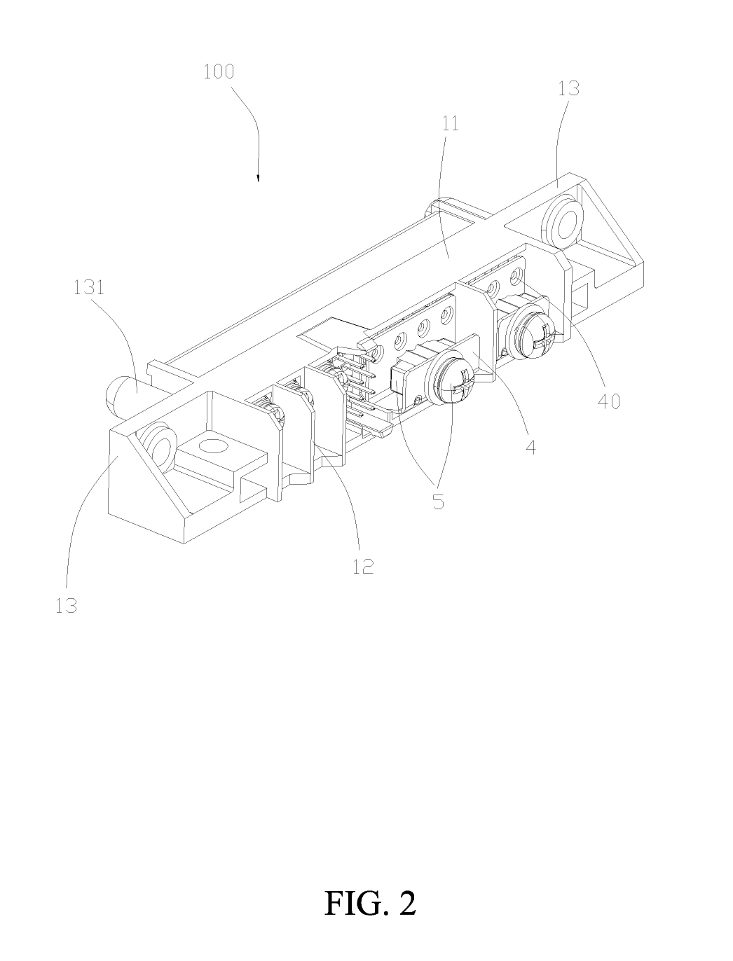

In the present embodiment, in three power contact slots 1121, the pair of power contacts 2 connect with each other respectively, that is the current transmitted in the power contact slot 1121 is equal to the total current through the pair of power contacts 2 respectively. Specifically, please refer together to FIGS. 2-6, the soldering pads 24 of said three pairs of power contacts 2 are provided with fixing hole (not shown), and each pair of the power contacts 2 is fixed with a first outer terminal by a screw 54, a nut 55 and the fixing holes.

In detail, the connecting pad 25 of the second contact 22 is located behind and overlaps with the connecting pad 25 of the first contact 21. Besides, the soldering pad 24 is adjacent to the connecting pad 25 along the top to bottom direction, and the soldering pad 24 and the connecting pad 25 are located at a common surface. Hence the soldering pads 24 of the first contact 21 and the second contact 22 overlap each other along the front to back direction too, and the fixing holes of the first and second contacts 21, 22 correspond to each other along the front to back direction. In the present embodiment, the soldering pad 24 connects with the connecting pad 25 along the top to bottom direction, but spaces from the contacting pad 23 along the front to back direction. Of course, in an alternative embodiment, the soldering pad 24 can also be designed to extend from the contacting pad 23 directly.

For transmitting high current, there are two groups of power contacts 2 connecting in series by one contact bus bar 4 respectively. One group comprises three pairs of the power contacts 2, and another group comprises four pairs of the power contacts 2. The power contacts 2 in said one group will be illustrated in detail hereinafter, and said another group will be omitted.

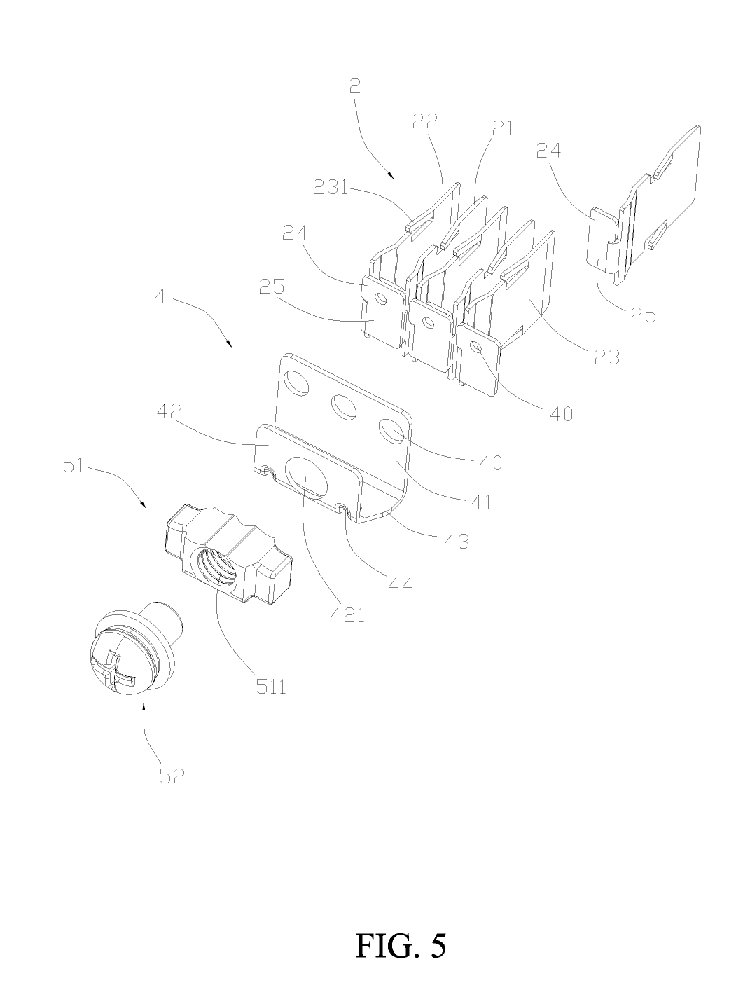

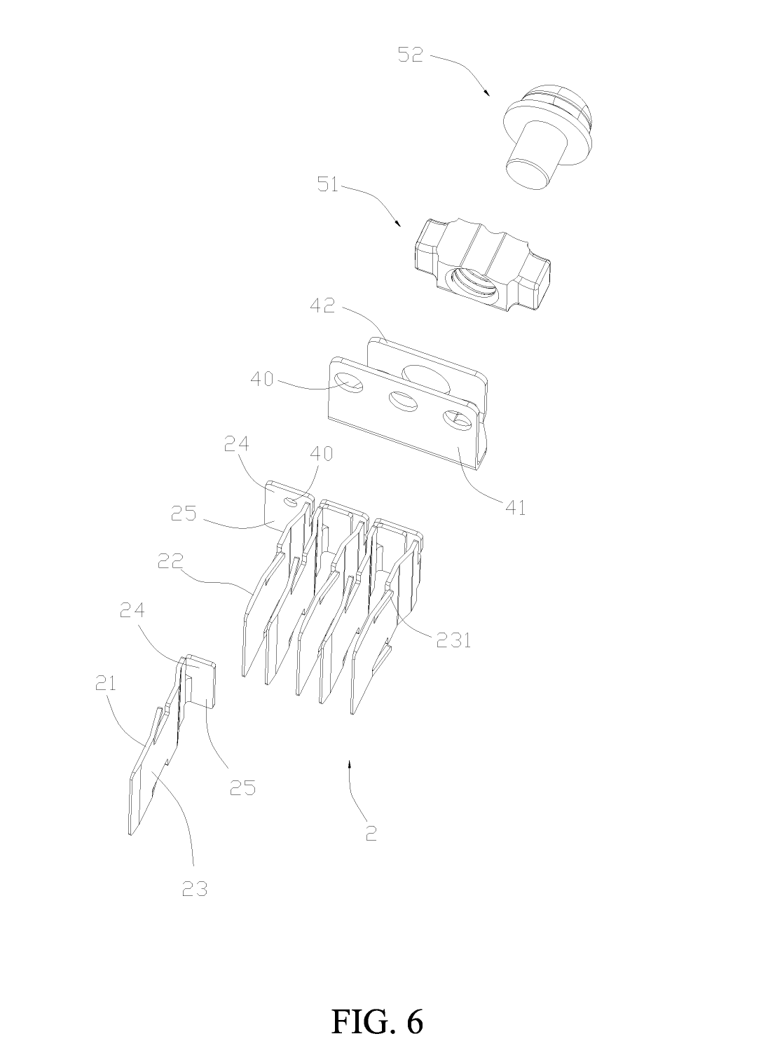

Referring to FIGS. 5 and 6, the soldering pads 24 of the power contacts 2 in said one group connect with a second outer terminal in series through the contact bus bar 4, therefore the current in the second outer terminal is equal to the total current through all power contacts 2 in said one group. The contact bas bar 4 is designed with a front mating pad 41 connecting with the soldering pads 24, a rear pad 42 opposite to the front mating pad 41 and a bridge 43 interconnecting the lower ends of the front mating pad 41 and the rear pad 42. The rear pad 42 connects with the second outer terminal. The front mating pad 41 and the rear pad 42 extend along the bottom-to-top direction and are parallel to each other. Taking the bridge 43 as a reference, the front mating pad 41 is higher than the rear pad 42. The bridge 43 is supported by the bottom wall 121 of the extension portion 12. At least one in the front mating pad 41 and the soldering pad 24 of the power contacts 2 in said one group is formed with a soldering hole 40, and the front mating pad 41 and the soldering pads 24 of the power contacts 2 in said one group are connected electrically via soldering tin set in the soldering hole 40.

In the present invention, the front mating pad 41 and some soldering pads 24 of the power contacts 2 in said one group are formed with said soldering hole 40. In detail, the soldering pads 24 of each pair of power contacts 2 in said one group are located at a front side of the front mating pad 41 and overlap each other along a front to back direction. The soldering pad 24 of the second contact 22 is sandwiched between the first contact 21 and the front mating pad 41. Hence the soldering pad 24 of the second contact 22 and the front mating pad 41 are provided with the soldering hole 40, and the soldering holes 40 of the second contact 22 and the front mating pad 41 correspond to each other along the front to back direction. The diameter of the soldering hole 40 of the second contact 22 is smaller than that of the soldering hole 40 of the front mating pad 41. The soldering pad 24 of the first contact 21 is not designed with the soldering hole 40. The front mating pad 41 and the soldering pads 24 of all power contacts 2 in said one group are connected electrically by soldering tin set in the soldering holes 40 of the second contacts 22 and the front mating pad 41.

Besides, because the soldering pad 24 and the connecting pad 25 are located at a common surface, then the connecting pads 25 of the second contacts 22 are sandwiched between the front mating pad 41 and the connecting pads 25 of the first contacts 21.

Referring to FIGS. 3 to 6, the fastening element 5 comprises a positioning nut 51 and a screw 52 interconnecting the contact bus bar 4 and the second outer terminal. The rear pad 42 defines a positioning hole 421. The positioning nut 51 is positioned between the front mating pad 41 and the rear pad 42 and defines a screw hole 511 corresponding to the positioning hole 421. The contact bus bar 4 is formed with a plurality of protrusions 44 to fix the positioning nut 51 between the front mating pad 41 and the rear pad 42. The protrusions 44 protrude upwardly from the bridge 43. The screw 52 extends through the positioning hole 421 and matches with the screw hole 511 to fix the second outer terminal and the rear pad 42 together.

As described above, the soldering pads 24 of the power contacts 2 in said two groups electrically connect with the contact bas bars 4 in series via soldering tin set in the soldering holes 40, that make the power connector 100 have a simple structure, be assembled easily and have a lower cost.

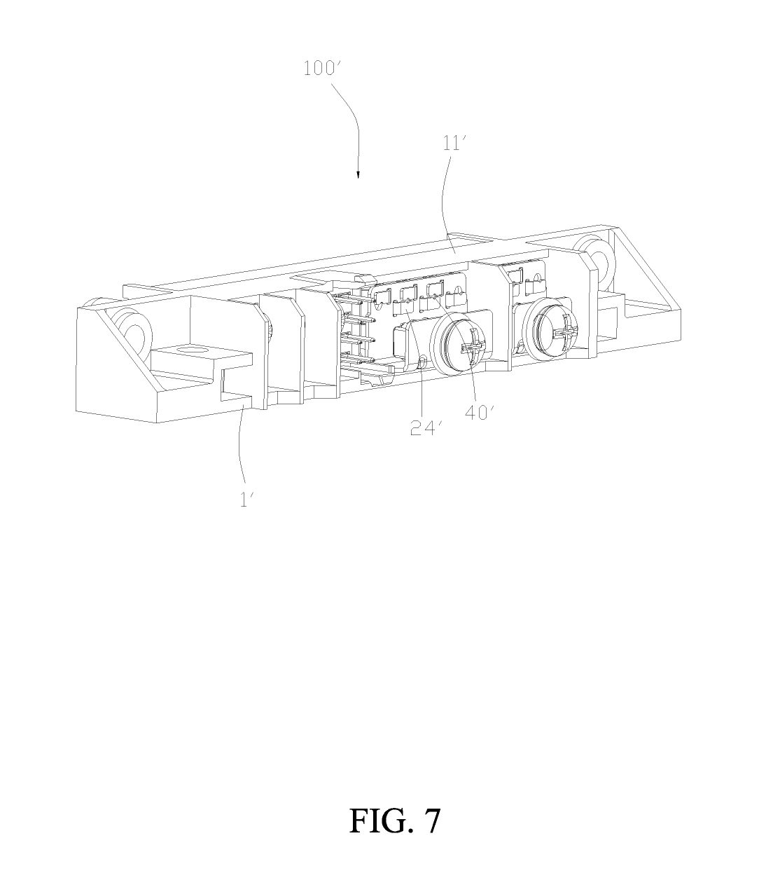

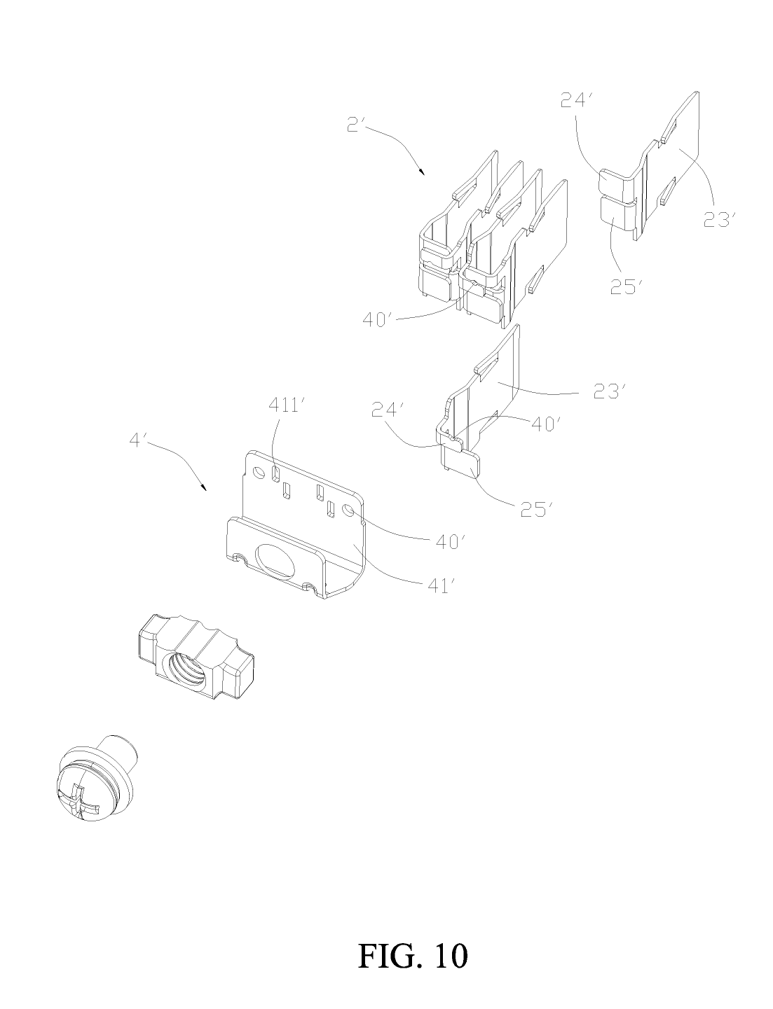

FIGS. 7 to 10 illustrates a power connector 100′ according to a second embodiment. Because the power connector 100′ is different from that of the first embodiment only in terms of the matching construction between the contact bas bar 4′ and the power contacts 2′ in said two groups, but is almost the same in terms of the other configurations, a description of what has not any different construction is not repeated.

In the second embodiment, the front mating pad 41′ of the contact bas bar 4′ is provided with a plurality of through holes 411′. Some soldering pads 24′ of the power contacts 2′ in the two groups cross the through holes 411′ and are positioned at a rear side of the front mating pad 41′, and said some soldering pads 24′ are all provided with the soldering holes 40′.

In detail, at least one soldering pad 24′ of the power contacts 2′ in each pair of the two groups extends through the through hole 411′ and is positioned at the rear side of the front mating pad 41′. When another soldering pad 24′ of the power contacts 2′ in each pair is not positioned at the rear side of the front mating pad 41′, said another soldering pad 24′ is located at the front side of the front mating pad 41′, and the front mating pad 41′ is designed with the soldering holes 40 to solder with said another soldering pad 24′ by soldering tin. When said another soldering pad 24′ of the power contacts 2′ in each pair also crosses through the through hole 411′ and is positioned at the rear side of the front mating pad 41′, said another soldering pad 24′ is also designed with the soldering hole 40′.

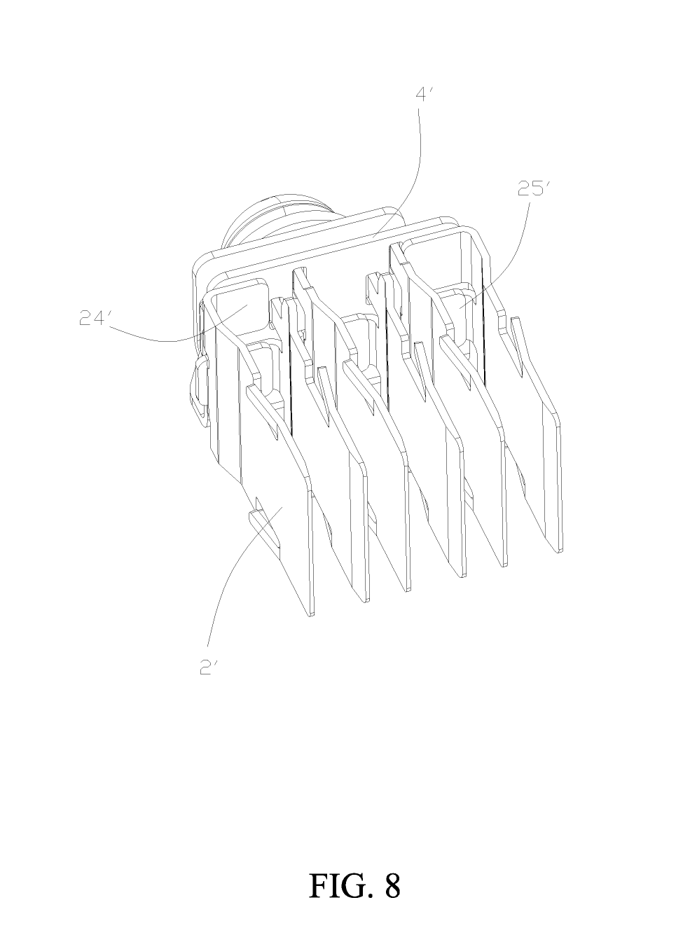

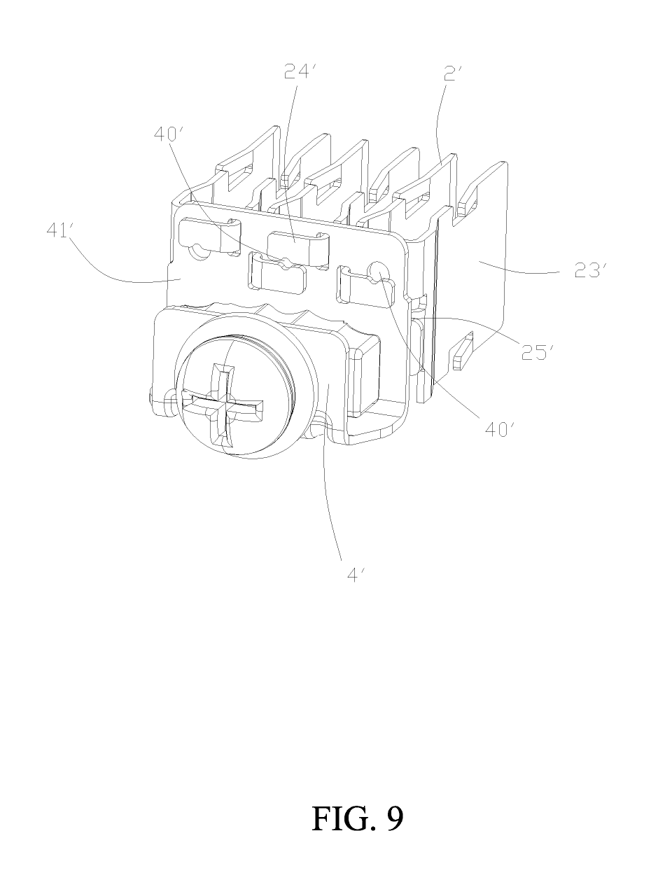

Referring to FIGS. 8 and 9, in the second embodiment, one soldering pad 24′ of the power contacts 2′ in each lateral pair of each group crosses through the through hole 411′ and is positioned at the rear side of the front mating pad 41′, and another soldering pad 24′ is located at the front side of the front mating pad 41′. All the soldering pads 24′ of the power contacts 2′ in the middle pair extend through the through hole 411′ and are positioned at the rear side of the front mating pad 41′. In the present embodiment, the soldering pads 24′ of the middle pair of the power contacts 2′ are arranged along the top to bottom direction, and the soldering holes 40′ are designed at adjacent side edges of the soldering pads 24′ and correspond to each other.

Besides, in the second embodiment, the soldering pad 24′ and the connecting pad 25′ all extend from the rear end of the contacting pad 23′, while the connecting pads 25′ are located at the front of the front mating pad 41′, and the connecting pads 25′ of the power contacts 2′ in each pairs overlap each other along the front to back direction.

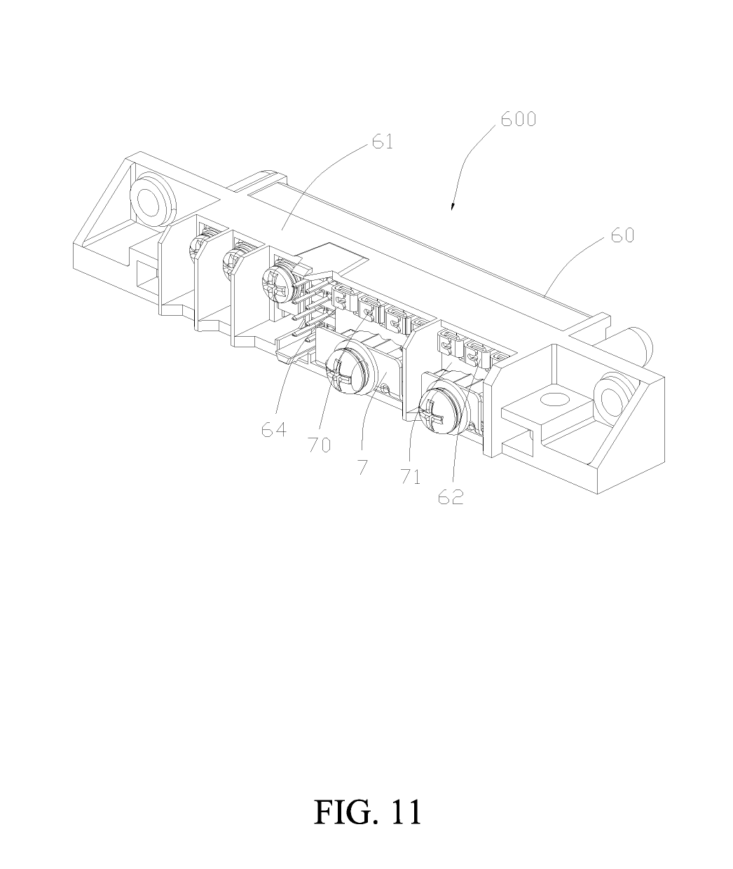

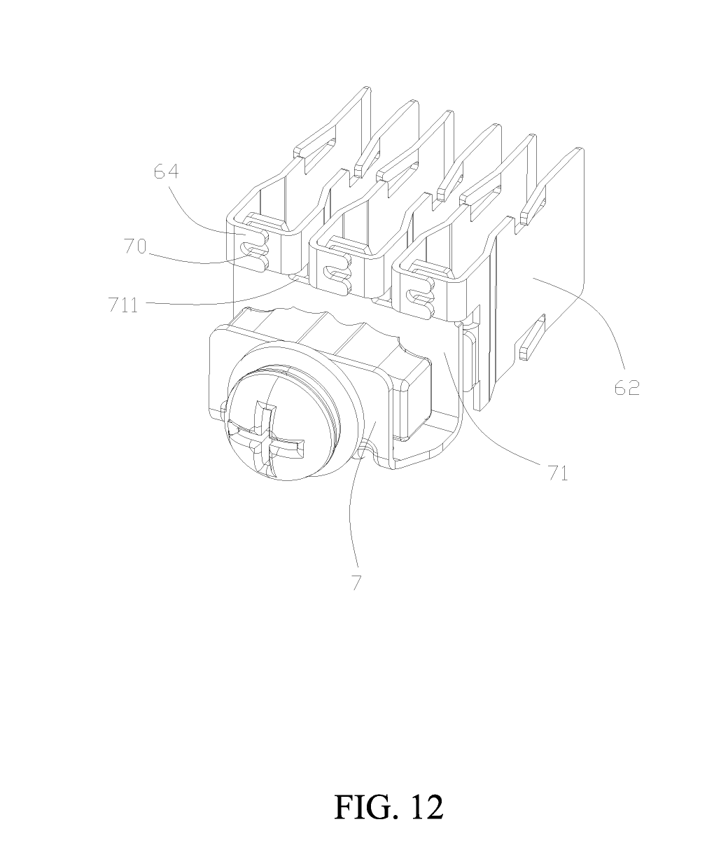

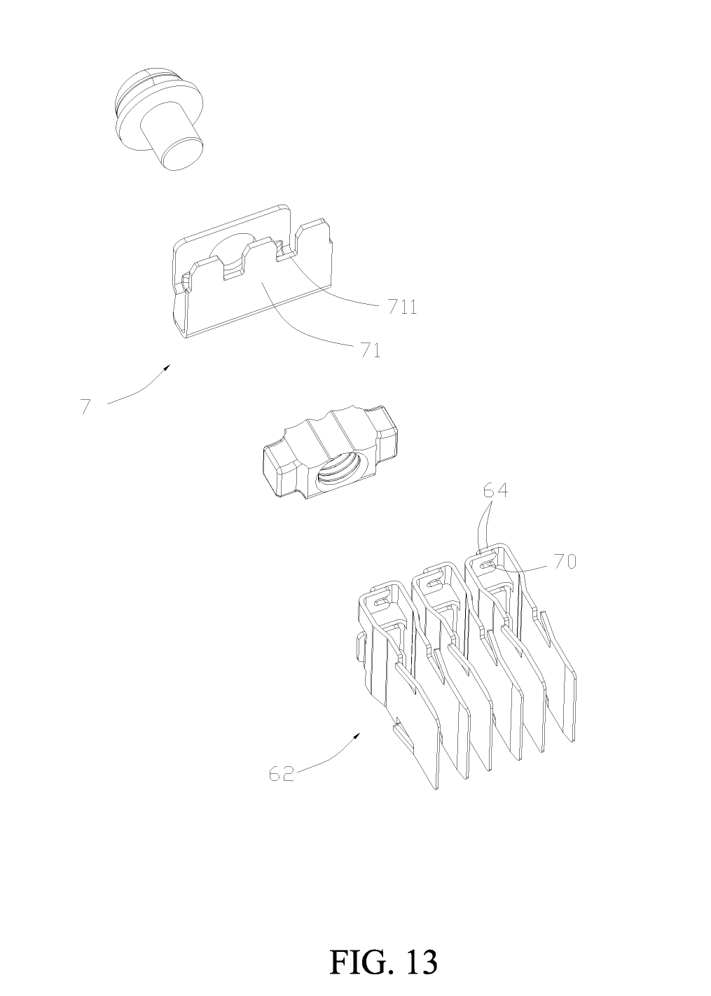

FIGS. 11 to 13 illustrates a power connector 600 according to a third embodiment, the power connector 600 is almost similar to that in the second embodiment. However, different from the second embodiment, the soldering pads 64 which contact with the contact bus bar 7 all cross through the through holes 711 defined in the contact bus bar 7, and the soldering pads 64 of the power contacts 62 in each pair overlap each other at the rear side of the front mating pad 71. The soldering holes 70 of the power contacts 62 in each pair correspond to each other along the front to back direction.

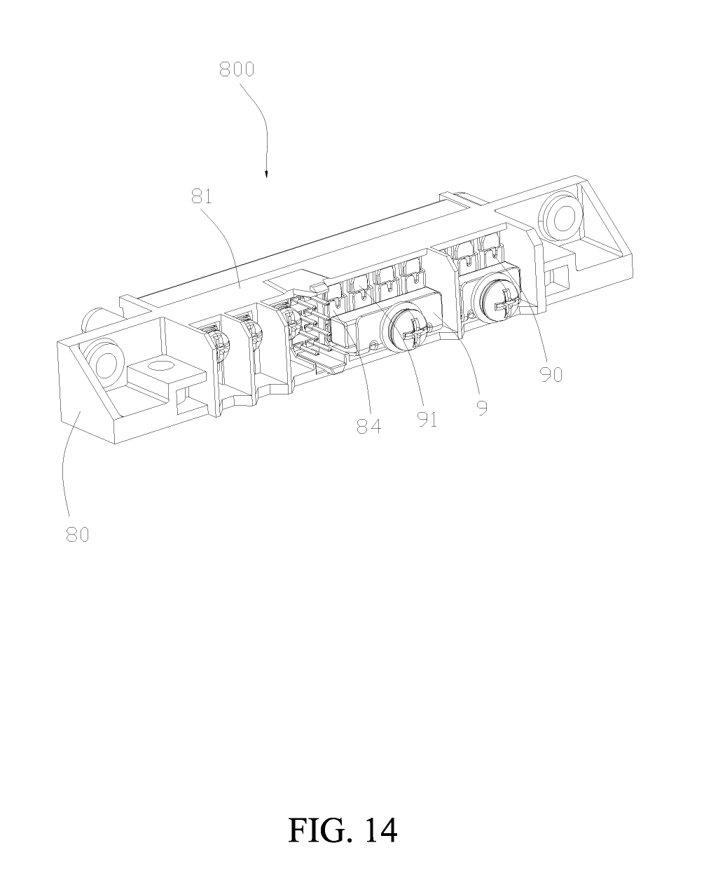

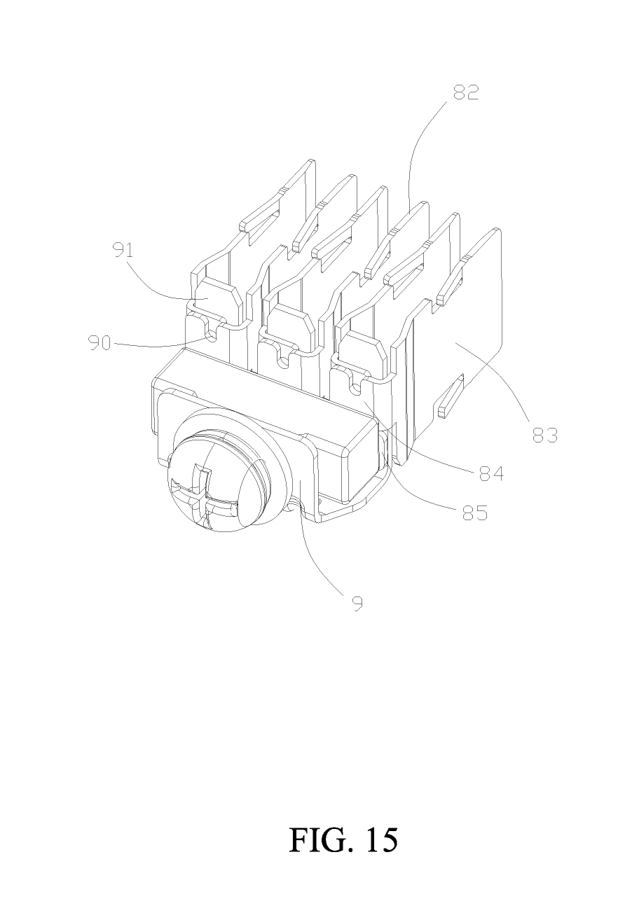

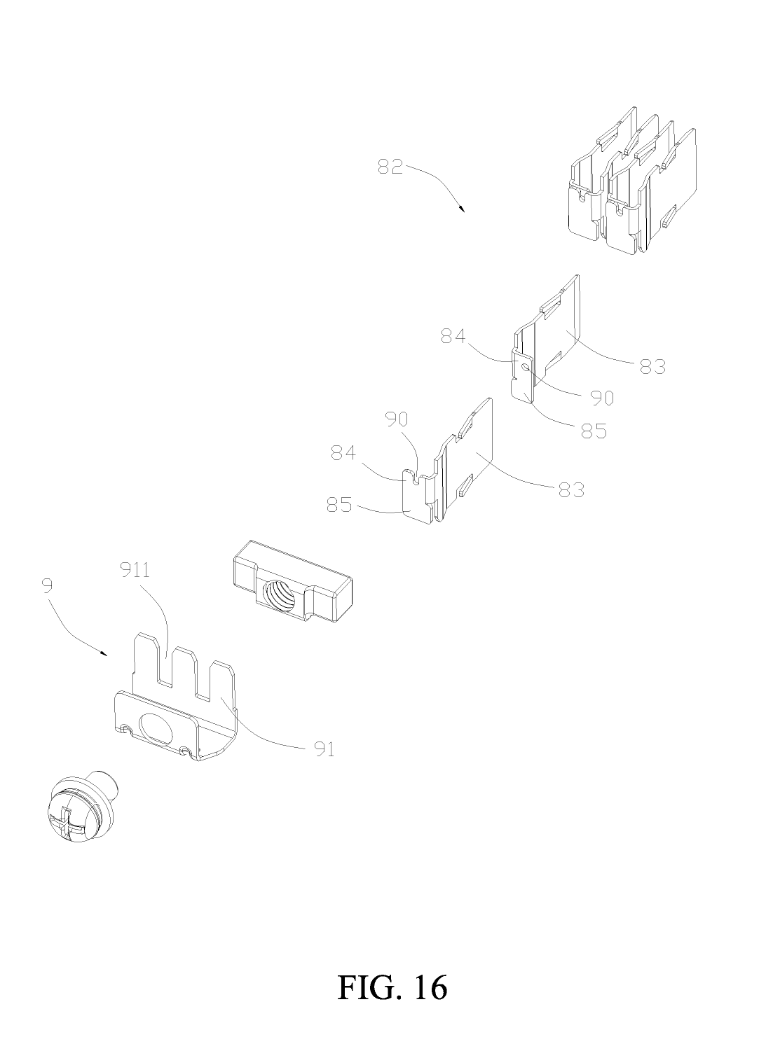

FIGS. 14 to 16 illustrates a power connector 800 according to a fourth embodiment. The power connector 800 is almost similar to that in the third embodiment, and the difference is that: not only the soldering pads 84 which contact with the contact bus bar 9 all cross through the through holes 911 defined in the contact bus bar 9, but also the connecting pads 85 all cross through the through holes 911 and are located at the rear side of the front mating pad 91. The connecting pads 85 are close to the front mating pad 91 too. The soldering pads 84 and the connecting pads 85 of the power contacts 82 in each pair overlap each other at the rear side of the front mating pad 71 respectively. Besides, the soldering pads 84 bend from the rear ends of the contacting pads 83, and the connecting pads 85 extend from the soldering pads 84 and space apart from the contacting pads 83 along the front to back direction.

According to above illustration of the power connector 100, 100′, 600 and 800, the present invention further discloses a method of making the power connector 100, 100′, 600 and 800. The method comprises: first, providing a plurality of power contacts 2, 2′, 62, 82 and an insulative housing 1, 1′, 60, 80 and fixing the power contacts 2, 2′, 62, 82 to the insulative housing 1, 1′, 60, 80, the power contacts 2, 2′, 62, 82 being provided with soldering pad 24, 24′, 64, 84; secondly, providing a contact bus bar 4, 4′, 7, 9 and a fastening element 5, and fastening the contact bus bar 4, 4′, 7, 9 and an outer terminal together via the fastening element 5, the contact bus bar 4, 4′, 7, 9 having a front mating pad 41, 41′, 71, 91 to engage with the power contacts 2, 2′, 62, 82, and at least one in the front mating pad 41, 41′, 71, 91 and the soldering pad 24, 24′, 64, 84 being formed with soldering hole 40, 40′, 70, 90; thirdly, fixing the contact bus bar 4, 4′, 7, 9, the fastening element 5 and the outer terminal to a rear side of the insulative housing 1, 1′, 60, 80 and enabling the front mating pad 41, 41′, 71, 91 of the contact bus bar 4, 4′, 7, 9 abut against the soldering pad 24, 24′, 64, 84; finally, welding the soldering pads 24, 24′, 64, 84 of the power contacts 2, 2′, 62, 82 and the front mating pad 41, 41′, 71, 91 at the position of the soldering hole 40, 40′, 70, 90 via soldering tin.

The contact bus bar 4, 4′, 7, 9, the fastening element 5 and the outer terminal are supported by the bottom wall 122 and clapboards 121. Besides, in the second, third and fourth embodiments, the contact bus bar 4′, 7, 9 is further positioned by the through holes 411′, 711, 911 designed on the front mating pad 41′, 71, 91, that enable the welding connection between the power contacts 2′, 62, 82 and the contact bus bar 4′, 7, 9 more conveniently, and the contact area is increased by the contact between the soldering pads 24′, 64, 84 and the front mating pad 41′, 71, 91.

As described above, the electrical connection between the contact bus bar 4, 4′, 7, 9 and the power contacts 2, 2′, 62, 82 can be realized by the soldering holes 40, 40′, 70, 90 and soldering tin, that can make the power connector 100, 100′, 600, 800 be produced and assembled easier. Besides, the structure of the power connector 100, 100′, 600, 800 can avoid many position elements, hence the cost for making the power connector 100, 100′, 600, 800 is down too.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

1. A power connector, comprising:
an insulative housing having a mating face at a front side thereof;
a plurality of power contacts received in the insulative housing;
a contact bus bar electrically connecting with the plurality of power contacts;
a fastening element fastening the contact bus bar and an outer terminal arranged behind the insualtive housing together;
wherein the power contacts are provided with soldering pads, and the contact bus bar has a front mating pad engaging with the soldering pads, at least one in the front mating pad and the soldering pad being formed with a soldering hole, and the front mating pad and the soldering pads being connected electrically via soldering tin set in the soldering hole.

2. The power connector as claimed in claim 1, wherein both the front mating pad and the soldering pad are formed with said soldering hole.

3. The power connector as claimed in claim 2, wherein the soldering pads are arranged at front of the front mating pad, and the soldering holes of the soldering pad and the front mating pad correspond to each other along the front to back direction, the diameter of the soldering hole of the power contact being smaller than that of the soldering hole of the front mating pad.

4. The power connector as claimed in claim 2, wherein the insulative housing defines a plurality of receiving slots, said power contacts are arranged in pairs in each receiving slot, and at least one power contact in each receiving slot contacting the front mating pad by the soldering pad thereof, and the soldering pad of said at least one power contact being designed with the soldering hole.

5. The power connector as claimed in claim 4, wherein the soldering pads of the power contacts in each receiving slot extend toward each other and overlap each other along a front to back direction.

6. The power connector as claimed in claim 1, wherein the front mating pad defines a plurality of through holes, and some soldering pads of the power contacts cross the through holes and engage with the rear side of the front mating pad, and said some soldering pads are provided with the soldering holes.

7. The power connector as claimed in claim 6, wherein the insulative housing defines a plurality of receiving slots, said power contacts are arranged in pairs in each receiving slot, and at least one soldering pad of the power contacts in each receiving slot extending through the through holes and engage with the rear side of the front mating pad.

8. The power connector as claimed in claim 7, wherein the soldering pads of the power contacts in each receiving slot are located at the front and rear sides of the front mating pad respectively, and the front mating pad is designed with the soldering hole which is used to connect with the soldering pad located at the front side of the front mating pad.

9. The power connector as claimed in claim 7, wherein all soldering pads of the power contacts in each receiving slot are formed with said soldering holes and extend through the through holes.

10. The power connector as claimed in claim 9, wherein the soldering pads of the power contacts in each receiving slot extend toward each other and are arranged in a top to bottom direction, and the soldering holes of the soldering pads are provided at adjacent sides of the soldering pads and communicate with each other.

11. The power connector as claimed in claim 9, wherein the soldering pads of the power contacts in each receiving slot extend toward each other and are arranged in the front to back direction, and the soldering holes of the soldering pads communicating with each other along the front to back direction.

12. The power connector as claimed in claim 11, wherein the power contacts in each receiving slot have connecting pads, and the connecting pads are sandwiched between the front mating pad and the fastening element or overlap each other along the front to back direction at a front side of the front mating pad.

13. The power connector as claimed in claim 1, wherein the contact bus bar is further provided with a rear pad and a bridge interconnecting the front mating pad and the rear pad, and the fastening element having a positioning nut located between the front mating pad and the rear pad and a screw behind the rear pad to engage with the positioning nut.

14. A method of making the power connector as claimed in claim 1, comprising:
providing a plurality of power contacts and an insulative housing, and fixing the power contacts to the insulative housing, the power contacts being provided with soldering pad;
providing a contact bus bar and a fastening element and fastening the contact bus bar and an outer terminal together via the fastening element, the contact bus bar having a front mating pad to engaging with the power contacts, and at least one in the front mating pad and the soldering pad being formed with soldering hole;
fixing the contact bus bar, the fastening element and the outer terminal to a rear side of the insulative housing and enabling the front mating pad of the contact bus bar abut against the soldering pad; and
welding the soldering pads of the power contacts and the front mating pad at the position of the soldering hole via soldering tin.
